(19) United States
(12) Patent Application Publication
(10) Pub. No.: US 2003/0221514 A1
(43) Pub. Date: Dec. 4, 2003

(54) Hollow shaft and method of manufacturing a hollow shaft

(76) Inventor: Peter Amborn, Neunkirchen (DE)

Correspondence Address: JORDAN AND HAMBURG LLP, 122 EAST 42ND STREET, SUITE 4000, NEW YORK, NY, 10168, US

(21) Appl. No.: 10/382,068

(22) Filed: Mar. 5, 2003

(30) Foreign Application Priority Data
Mar. 19, 2002 (DE) 102 12 047.1-12

(51) Int. Cl. F16C 3/04

(52) U.S. Cl. 74/595

(57) ABSTRACT

The subject matter of the invention is a hollow shaft with power transmission members such as cams of a camshaft, crown gears of a gear shaft or journals of a crankshaft disposed one behind the other in an axial direction, the power transmission members being configured to be at least partially hollow, said power transmission members being configured integral with the hollow shaft and the material being hardenable at least in the region of the power transmission members.

### BACKGROUND OF THE INVENTION

1. Field of the Invention

The present invention relates to a hollow shaft with power transmission members such as cams of a camshaft, crown gears of a gear shaft or journals of a crankshaft that are disposed one behind the other in an axial direction and to a method of manufacturing such a hollow shaft.

2. Description of the Prior Art

Usually, camshafts and crankshafts are swaged. It is however also known to manufacture such shafts in a casting operation, whereby it is absolutely possible to make said shafts hollow in the very region of the shaft which, in the simplest case, is achieved by inserting suited cores.

In the automotive industry in particular, there is a constant need to reduce weight. Therefore, and as already known in the art, hollow shafts are made. The manufacturing of such hollow shafts in a casting operation is complicated though and the thus obtained shafts are still quite heavy.

DE 199 09 184 C2 discloses a method of manufacturing a camshaft and a camshaft manufactured according to this method that is configured to form an elongated hollow body, metallic rings being hooped in the region of the cams for the purpose of providing material needed for deformation. The elongated hollow body is more specifically placed into a mold in which the metallic rings that are to later form the cams have already been placed. After the metallic elongated hollow body has expanded, it forms a form-positive and self-adhering connection with the metallic rings.

U.S. Pat. No. 5,992,197 discloses a method of manufacturing an elongated hollow body with cam-like thickenings disposed along the axial length thereof, material being at first fed to the region of said cam-like thickenings on the inner wall of the elongated hollow body by compressing the hollow body for example, the elongated hollow body being deformed to obtain a cam-like shape by applying an internal pressure onto, and by heating, the region to which material has been fed. As already explained, it is for this purpose necessary to first feed material, which is more specifically achieved by compressing the elongated hollow body, said elongated hollow body being heated during compression at the sites where material is to be fed. The cam-like thickenings are then formed from said fed material; it will be obvious therefrom that the manufacturing process involves several operating cycles.

### BRIEF SUMMARY OF THE INVENTION

It is therefore the object of the present invention to provide a hollow shaft of the type mentioned herein above that is lighter than the prior art shaft and that moreover is easy and affordable to manufacture.

The subject matter of the invention is therefore a hollow-shaft with power transmission members such as cams of a camshaft, crown gears of a gear shaft or journals of a crankshaft disposed one behind the other in an axial direction, the power transmission members being configured to be at least partially hollow in order to reduce the weight thereof, said power transmission members being configured integral with the hollow shaft and the material being hardenable at least in the region of the power transmission members. By “configured integral” it is meant that in its initial state already the hollow body is made in one piece.

According to a first variant, a method of manufacturing such a hollow shaft is characterized in that the elongated hollow body configured as a blank is completely smooth on the inner and outer circumference thereof, meaning it has no gradations, no material having been fed thereto in the manner known in the art according to U.S. Pat. No. 5,992,197. According to this first variant, the manufacturing process for the hollow shaft more specifically involves the steps of placing the elongated hollow body into a tool mold, said tool mold having an inner contour matching the final contour of the hollow shaft; there is further provided that internal pressure is applied onto the heated elongated hollow body and that said elongated hollow body is compressed. In contrast to the prior art according to U.S. Pat. No. 5,992,197, no material needs to be provided to form the power transmission members. Here, the hollow shaft is manufactured in one single step which consists in compressing the heated hollow body.

In contrast to the method described in DE 199 09 184, the manufacturing method of the invention described herein above permits to make a hollow shaft from one single initial piece having the form of an elongated hollow body, the deformation and the material needed therefor in the region of the power transmission members being obtained by compressing the elongated hollow body in its heated condition.

According to a second variant, a method of manufacturing a hollow shaft is characterized by an elongated hollow body having a smooth inner circumference, material needed for deformation being provided on the outer circumference of said elongated hollow body in the region of the power transmission members, said material being configured in this region so as to match the final contour of the hollow shaft, the hollow body being characterized by a higher temperature in the region of the material needed for deformation as compared to regions neighbouring the hollow body and an internal pressure being applied to the hollow body.

The important point thereby is that the material provided in the region of the future power transmission members, of a cam for example, already shows the contour of said cam. In the example of the camshaft the advantages obtained with this manufacturing method (second variant) are particularly obvious as the cam shows an irregular material distribution on its circumference.

Although the U.S. Pat. No. 5,992,197 also provides for material being fed to the region of the elongated hollow body, said material, which is fed to the inner circumference thereof, will have differing cross-sectional regions once the cam is formed. At the sites where the cam has been extremely deformed, the material will be relatively thin whereas at the sites where the cam was subjected to a small deformation only the material will accordingly be thicker. This is precisely where the invention according to this second variant sets in; for, as there is more material provided in the region where the cam is extremely deformed than in the region of smaller deformation of the cam, it is made certain that the cam has approximately even material thickness on its entire surface. This is not only obtained by accordingly providing the material on the elongated hollow body but also by maintaining through internal pressure a differentiated radial temperature distribution in the region of the material during deformation. This means that, in the regions in which there is more mass of the material needed for deformation, the temperature is higher than in the regions in which there is less mass. Thus, the cam may take a substantially even shape within the tool mold.

The interesting feature of this method is that no compression is needed here—as contrasted with the prior art method according to U.S. Pat. No. 5,992,197. In the present case, the material needed for deformation may already be provided in the initial state of the hollow body, when said hollow body is configured as a cast blank or a forging blank for example, without further steps having to be performed prior to the actual deformation process as this is the case in the method according to the U.S. Patent Document in which material must first be fed by compression. Also, all of the cams may be formed simultaneously and need not be formed consecutively as this is the case with the first variant.

Further advantageous features of the two variants will become apparent from the subordinate claims.

In an alternative, there is more specifically provided that the hollow body is heated in the tool mold. The hollow body is thereby heated inside the tool mold either by induction or by way of heating elements disposed within the tool mold. According to a second alternative it is also possible to heat the hollow body according to the extent of deformation required prior to placing it into the tool mold. A third possible alternative consists in combining these two alternatives so that the hollow body is pre-heated prior to being placed into the tool mold and that, after having been placed inside the tool mold, said hollow body is heated in the tool mold to the desired temperature profile.

More specifically with regard to the first variant there is provided that the elongated hollow body is heated continuously from the inside toward the outside in an axial direction, the greatest heating effect being advantageously produced in the region of the highest extent of deformation, meaning that the greatest heating effect is more specifically produced in the region of the power transmission members. This signifies that, to manufacture such a hollow body, the elongated hollow body in the form of a blank is at first placed into a tool mold, that said elongated hollow body is heated in the region of the center thereof, that an internal pressure is applied to the entire hollow body, the elongated hollow body being compressed after the maximum heating temperature is reached so that the elongated hollow body first takes the contour of the tool mold in the center region thereof. The temperature in the region of the power transmission member to be formed, the cam for example, may differ over the circumference of the hollow body, e.g., the temperature may be higher in the region of the power transmission member to be formed that is subjected to only a small deformation (small extent of deformation) than in the region of the power transmission member that is subjected to a greater extent of deformation or vice versa.

Once the hollow body has taken its final contour in this region, the hollow body is further gradually heated in an axial direction toward the outer ends thereof, the hollow body being continuously compressed during heating in order to feed the material needed for deformation inside the tool mold. Accordingly, according to another feature of the invention, there is provided that the elongated hollow body is compressed to an extent that corresponds to the progressive heating of the hollow body from the inside toward the outside. Meaning, it is compressed to the extent needed to feed the material necessary for the time dependent filling of the contour. Advantageously, compression is thereby performed on either end of the hollow body and a gas or a fluid may be used to apply an internal pressure to the elongated hollow body.

The invention will be described in greater detail by way of example with reference to the drawing.

### BRIEF DESCRIPTION OF THE SEVERAL VIEWS OF THE DRAWING

FIG. 1 illustrates the hollow body placed inside the tool mold for the formation of two cams;

FIG. 2 is a schematic view of the hollow body with two formed cams;

FIG. 3 shows the hollow body inside the tool mold;

FIG. 4 is a view of the hollow body according to FIG. 3 with two additional formed cams located on the outer side as viewed in an axial direction;

FIG. 5 shows the hollow body provided with material needed for deformation disposed on the outer circumference thereof, said material corresponding to the final contour of the cams as viewed in a radial direction;

FIG. 6 is a sectional view taken along the line A-A of FIG. 5.

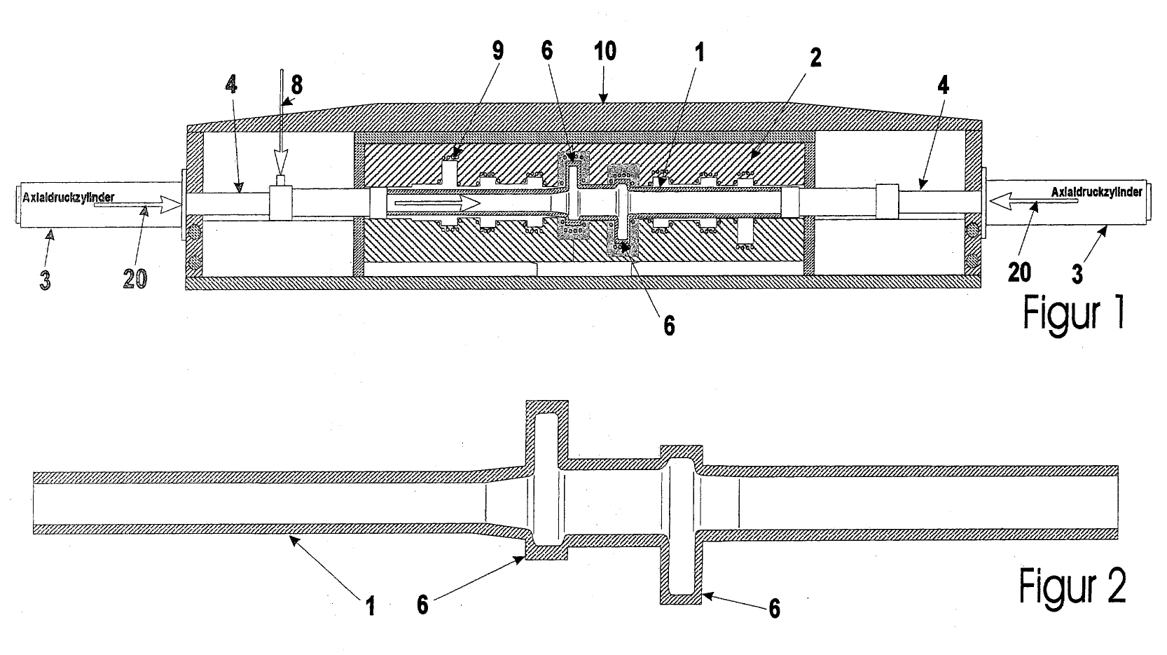

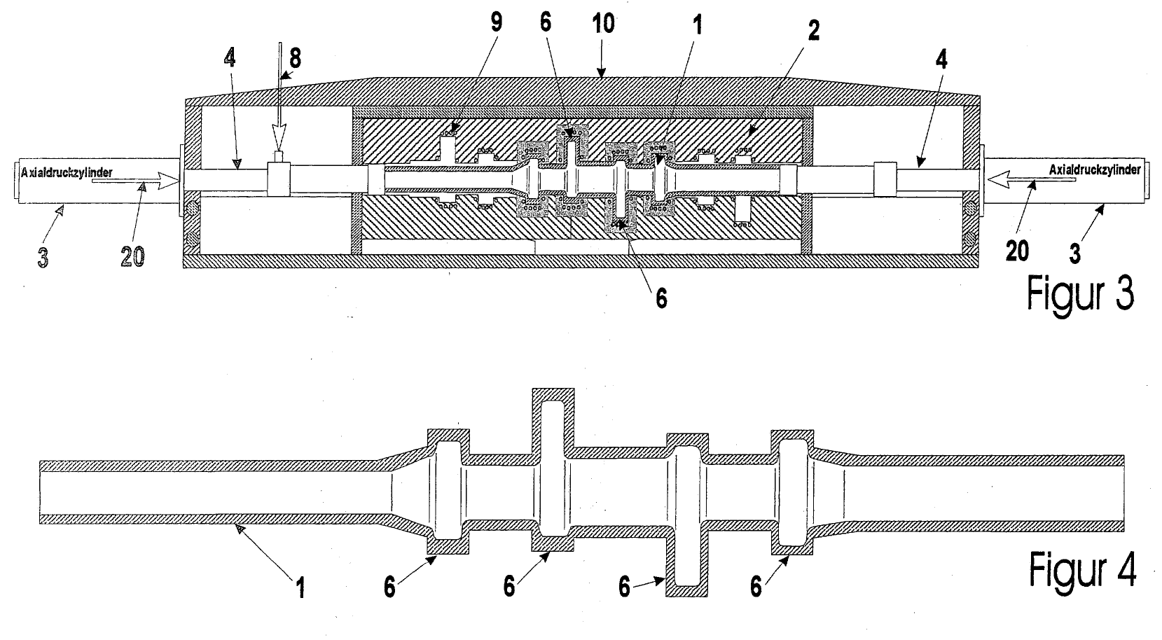

### DETAILED DESCRIPTION OF THE INVENTION

The drawing shows in a schematic form a camshaft 1 placed inside a tool mold 2. The contour of the tool mold 2 is configured to conform to the final contour of the camshaft 1. As may be surveyed from the drawing, what will be termed an axial pressure cylinder 3 is provided on either side of the tool mold 2 and compresses (first variant) the elongated hollow body indicated at 1 on either side (arrow 20) by means of appropriate punches 4. The punch 4 has an inlet port 8 for the gas used to apply an internal pressure to the hollow body, with gas for example. During compression, the circumference of the hollow body is heated by the heating elements 9 provided in the tool mold. In order to fill out the cavity in the tool mold, the central regions (arrow 10) of the tool mold are heated first. The material then flows into the cavity at the corresponding axial compression pressure and at the corresponding internal pressure. Once the formation of the two central cams 6 is completed, the end regions are progressively heated so that, two by two, further cams are formed. Once the forming process is completed in the entire cavity of the tool mold, the workpiece in the form of the camshaft may be removed from the tool mold and conducted to further hardening processes e.g., a direct hardening using the residual heat from the deformation process.

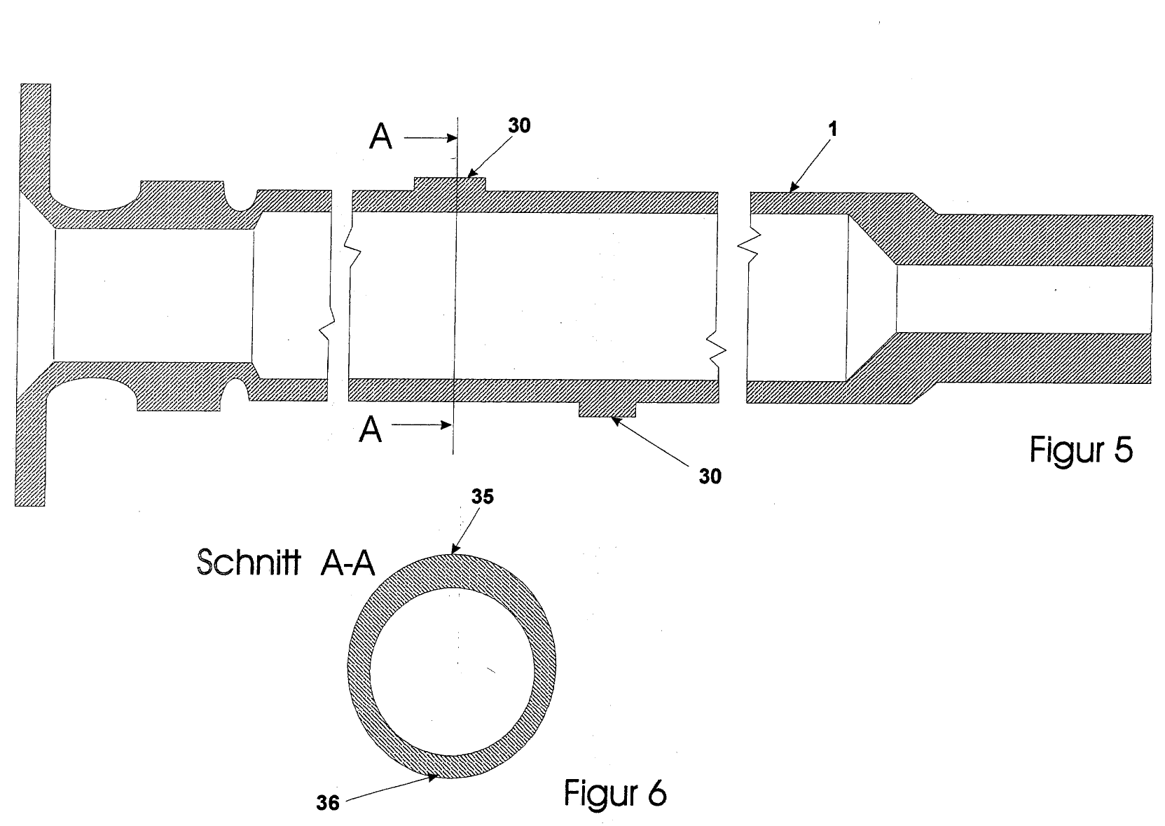

The second variant (FIG. 5, FIG. 6) of the manufacturing process only differs from the first variant in that here, the elongated hollow body is provided on its outer circumference with material needed for deformation 30, the outer contour of said material substantially corresponding to the final contour with regard to the material distribution of the completed power transmission member e.g., the cam of a camshaft. Meaning, the material distribution on the circumference varies in radial direction. Such an elongated hollow body 1 provided, on the outer circumference thereof, with the corresponding material needed for deformation 30 is also placed into the tool mold according to the FIGS. 2 and 4. In this case however, the final shape is obtained by only applying an internal pressure without the elongated hollow body having to be compressed. As a matter of fact, this is not necessary since no material needs to be fed by compression in order to form the cams. What is necessary though is that the region where the material needed for deformation is provided be heated to a greater extent than the border regions; there is more specifically provided that the material needed for deformation is also heated to different temperatures over its depth as viewed in a radial direction, i.e., that at the sites where the material needed for deformation has a large cross-section (FIG. 6, arrow 35) the temperature is higher than in the region indicated by the arrow 36 in which the quantity of material is small.

I claim:

1. A hollow shaft with power transmission members such as cams of a camshaft, crown gears of a gear shaft or journals of a crankshaft disposed one behind the other in an axial direction, the power transmission members being configured to be at least partially hollow, said power transmission members being configured integral with the hollow shaft and the material being hardenable at least in the region of the power transmission members.

2. A method of manufacturing a hollow shaft according to claim 1 from an elongated hollow body having a smooth inner and outer circumference involving the following steps:
the elongated hollow body (1) is placed into a tool mold (2), said tool mold (2) having an inner contour that conforms to the final contour of the hollow shaft;
an internal pressure is applied to the heated elongated hollow body which is compressed in an axial direction.

3. The method of manufacturing a hollow shaft according to claim 1 from an elongated hollow body having a smooth inner circumference, the elongated hollow body being provided, on the outer circumference thereof, in the region of the power transmission members, with material needed for deformation, said material being configured in this region to conform to the final contour of the hollow shaft, the hollow body being characterized by a higher temperature in the region of the material needed for deformation as compared to regions neighbouring the hollow body, and an internal pressure being applied to the hollow body.

4. The method of manufacturing a hollow shaft according to claim 2, characterized in that the tool mold (2) is heated to heat the hollow body.

5. The method of manufacturing a hollow shaft according to claim 2,
characterized in that the hollow body (1) is heated according to the extent of deformation required prior to being placed in the tool mold (2).

6. The method of manufacturing a hollow shaft according to claim 2,
characterized in that the hollow body (1) is pre-heated prior to being placed in the tool mold (2) and that the hollow body is heated by said tool mold to the desired temperature profile after having been placed in said tool mold.

7. The method of manufacturing a hollow shaft according to claim 2,
characterized in that the elongated hollow body (1) is progressively heated from the inside to the outside in an axial direction.

8. The method of manufacturing a hollow shaft according to claim 2,
characterized in that the greatest heating effect is produced in the region of the highest extent of deformation.

9. The method of manufacturing a hollow shaft according to claim 2,
characterized in that the greatest heating effect is produced in the region of the power transmission members.

10. The method of manufacturing a hollow shaft according to claim 2,
characterized in that the elongated hollow body (1) is compressed to an extent that corresponds to the progressive heating of the hollow body (1) from the inside toward the outside.

11. The method of manufacturing a hollow shaft according to claim 2,
characterized in that the elongated hollow body (1) is compressed from either end of the hollow body.

12. The method of manufacturing a hollow shaft according to claim 2,
characterized in that a gas or a fluid may be used to apply an internal pressure.

13. The method of manufacturing a hollow shaft according to claim 2,
characterized in that the hollow body (1) is a cast blank or a forging blank.

14. The method of manufacturing a hollow shaft according to claim 13,
characterized in that the material needed for deformation is integrally formed, e.g., integrally forged or molded.

15. The method of manufacturing a hollow shaft according to claim 2,
characterized in that the hollow body (1) is heated by induction.

16. The method of manufacturing a hollow shaft according to claim 6,
characterized in that the tool mold (2) is provided with heating elements for heating the hollow body (1).

17. The method of manufacturing a hollow shaft according to claim 3,
characterized in that the temperature distribution in the region of the material needed for deformation increases radially as the mass increases.

18. The method of manufacturing a hollow shaft according to claim 2,
characterized in that the workpiece is conducted to further hardening processes e.g., hardening, using the residual heat from the deformation process.

19. The method of manufacturing a hollow shaft according to claim 2, characterized in that, in the region of the power transmission member to be formed, the temperature varies on the circumference of said power transmission member.
